(19) United States
(12) Patent Application Publication
(10) Pub. No.: US 2025/0079084 A1
(43) Pub. Date: Mar. 6, 2025

(54) DIELECTRIC COMPOSITION AND MULTILAYERED CAPACITOR CONTAINING THE SAME

(71) Applicant: SAMSUNG ELECTRO-MECHANICS CO., LTD., Suwon-si (KR)

(72) Inventors: Yonghwa Lee, Suwon-si (KR); Seung Yong Lee, Suwon-si (KR); Minsoo Kim, Suwon-si (KR); Sang Jin Park, Suwon-si (KR); Jinbok Shin, Suwon-si (KR)

(73) Assignee: SAMSUNG ELECTRO-MECHANICS CO., LTD., Suwon-si (KR)

(21) Appl. No.: 18/680,355

(22) Filed: May 31, 2024

(30) Foreign Application Priority Data
Sep. 5, 2023 (KR) 10-2023-0117923
Dec. 1, 2023 (KR) 10-2023-0172458

(51) Int. Cl. H01G 4/12; C04B 35/468; H01G 4/30

(52) U.S. Cl. CPC H01G 4/1227; C04B 35/4682; H01G 4/30; C04B 2235/3236; C04B 2235/40; C04B 2235/428

(57) ABSTRACT

A dielectric composition according to the present disclosure includes dielectric grains containing barium titanate-based compounds; and a secondary phase located between the dielectric grains, and the secondary phase includes a first secondary phase including Ga and Si. A multilayered capacitor includes a capacitor body including a dielectric layer and an internal electrode; and an external electrode disposed outside the capacitor body. The dielectric layer includes the dielectric composition according to the present disclosure.

### CROSS-REFERENCE TO RELATED APPLICATION

This application claims priority to and the benefit of Korean Patent Application No. 10-2023-0172458 filed in the Korean Intellectual Property Office on Dec. 1, 2023, and Korean Patent Application No. 10-2023-0117923 filed in the Korean Intellectual Property Office on Sep. 5, 2023, the entire contents of which are incorporated herein by reference.

### BACKGROUND

### (a) Technical Field

The present disclosure relates to a dielectric composition and a multilayered capacitor containing the same.

### (b) Description of the Related Art

In recent years, as the multifunctionalization and miniaturization of electronic devices progress rapidly, the miniaturization and performance improvement of electronic components is progressing rapidly. In addition, the demand for high reliability of electronic devices used for automobiles or network equipment, and electronic components used for industrial use is significantly increasing.

In order to meet such market demands, technology development competition of passive components such as inductor, capacitor, or resistor is accelerating. In particular, with the development of various products related to a multilayer ceramic capacitor (MLCC) as the passive component, which is continuously increasing in terms use and usage, a lot of efforts for preoccupying have been required.

In addition, the multilayer ceramic capacitor as a capacitor manufactured in a form in which dielectric layers and internal electrode are stacked in layers is used for various electronic devices such as mobile phones, laptops, and LCD TVs. As the miniaturization and high functionalization of electronic devices progresses, technology for miniaturizing and thinning of laminated capacitors is required.

As the multilayer ceramic capacitors are miniaturized and thinned, phenomena such as internal voltage characteristics of the capacitor, the reduction of reliability, and the decrease in dielectric constant rate are generated, and in order to solve the phenomena, it is required to lower a sintering temperature when manufacturing the multilayer ceramic capacitor. However, lowering the sintering temperature reduces the compactness and degrades the reliability of the dielectric.

### SUMMARY

On aspect of an embodiment provides a dielectric composition in which pore compactness is improved by lowering a sintering temperature of a dielectric.

Another aspect of the embodiment provides a multilayered capacitor which includes the dielectric composition to have enhanced dielectric characteristics and moisture resistance reliability.

However, the problems to be solved by the embodiments of the present disclosure are not limited to the above-mentioned problems, but can be variously extended within the scope of the technical spirit included in the embodiments.

A dielectric composition according to an embodiment includes: dielectric grains including a barium titanate based compound; and a secondary phase located between the dielectric grains, and
the secondary phase includes a first secondary phase including Ga and Si.

The dielectric grains including the barium titanate-based compounds may be a primary phase, and
the primary phase may have an average area of 85% or more of a total area of the dielectric composition, and
the secondary phase may have an average area of 15% or less of the total area of the dielectric composition.

The first secondary phase may further include Al and Mg.

The first secondary phase may include, with respect to 1 part by mol of Ga: Si in an amount of 1.0 part by mol to 3.0 parts by mol, Al in an amount of 0.5 parts by mol to 2.5 parts by mol, and Mg in an amount of 0.2 parts by mol to 1.2 parts by mol.

An average area (%) occupied by the first secondary phase with respect to a total area of the secondary phase may be 50% to 95%.

The secondary phase may further include a second secondary phase which includes Si and is free of Ga, and an average area (%) occupied by the second secondary phase with respect to the total area of the secondary phase may be 5% to 50%.

A ratio of the average area occupied by the first secondary phase with respect to the total area of the secondary phase to the average area occupied by the second secondary phase with respect to the total area of the secondary phase may be 1.5 to 2.5.

The dielectric composition may include Ga in an amount of 0.1 wt % to 0.5 wt %.

A multilayered capacitor according to another embodiment includes: a capacitor body including a dielectric layer and an internal electrode; and an external electrode disposed outside the capacitor body, and
the dielectric layer includes dielectric grains including a barium titanate-based compound, and a secondary phase located between the dielectric grains, and
the secondary phase includes a first secondary phase including Ga and Si.

The dielectric grains including the barium titanate-based compound may be a primary phase, and the primary phase may have an average area of 85% or more of a total area of the dielectric layer, and the secondary phase may have an average area of 15% or less of the total area of the dielectric layer.

The first secondary phase may further include Al and Mg.

The first secondary phase may include, with respect to 1 part by mol of Ga: Si in an amount of 1.0 part by mol to 3.0 parts by mol, Al in an amount of 0.5 parts by mol to 2.5 parts by mol, and Mg in an amount of 0.2 parts by mol to 1.2 parts by mol.

An average area (%) occupied by the first secondary phase with respect to a total area of the secondary phase may be 50% to 95%.

The secondary phase may further include a second secondary phase which includes Si and is free of Ga and an average area (%) occupied by the second secondary phase with respect to the total area of the secondary phase may be 5% to 50%.

A ratio of the average area occupied by the first secondary phase with respect to the total area of the secondary phase to the average area occupied by the second secondary phase with respect to the total area of the secondary phase may be 1.5 to 2.5.

The dielectric layer may include Ga in an amount of 0.1 wt % to 0.5 wt %.

A manufacturing method of a multilayered capacitor according to yet another embodiment includes: manufacturing dielectric powder including gallium (Ga), wherein the manufacturing of the dielectric powder including the gallium (Ga) includes adding gallium (Ga) having an average particle diameter of 1 nm to 15 nm to a precursor of a barium titanate-based dielectric;
manufacturing a dielectric green sheet by utilizing the dielectric powder, and forming a conductive paste layer on a surface of the dielectric green sheet;
manufacturing a dielectric green sheet laminate by laminating a plurality of the dielectric green sheets, wherein the conductive paste layer is formed on each of the plurality of the dielectric green sheets;
manufacturing a capacitor body including a dielectric layer and internal electrodes by sintering the dielectric green sheet laminate; and
forming an external electrode on one surface of the capacitor body.

A sintering temperature of the sintering of the dielectric green sheet laminate may be 1000° C. to 1200° C.

A dielectric composition according to an embodiment includes: dielectric grains including a barium titanate based compound; and a secondary phase located between the dielectric grains, the secondary phase including a first secondary phase including Ga and Si, and a second secondary phase which includes Si and is free of Ga.

The dielectric composition may be free of rare-earth elements.

The first secondary phase may further include Al and Mg.

The first secondary phase may include, with respect to 1 part by mol of Ga: Si in an amount of 1.0 part by mol to 3.0 parts by mol, Al in an amount of 0.5 parts by mol to 2.5 parts by mol, and Mg in an amount of 0.2 parts by mol to 1.2 parts by mol.

The dielectric composition may include Ga in an amount of 0.1 wt % to 0.5 wt %.

A multilayered capacitor according to another embodiment includes: a capacitor body including a dielectric layer and an internal electrode; and an external electrode disposed outside the capacitor body, and the dielectric layer includes dielectric grains including a barium titanate-based compound, and a secondary phase located between the dielectric grains, and the secondary phase includes a first secondary phase including Ga and Si, and a second secondary phase which includes Si and is free of Ga.

The dielectric composition may be free of rare-earth elements, the dielectric grains including the barium titanate-based compound may be a primary phase, the primary phase may have an average area of 85% or more of a total area of the dielectric layer, and the secondary phase may have an average area of 15% or less of the total area of the dielectric layer.

The first secondary phase may further include Al and Mg.

The first secondary phase may include, with respect to 1 part by mol of Ga: Si in an amount of 1.0 part by mol to 3.0 parts by mol, Al in an amount of 0.5 parts by mol to 2.5 parts by mol, and Mg in an amount of 0.2 parts by mol to 1.2 parts by mol.

The dielectric layer may include Ga in an amount of 0.1 wt % to 0.5 wt %, an average area (%) occupied by the first secondary phase with respect to a total area of the secondary phase may be 50% to 95%, and an average area (%) occupied by the second secondary phase with respect to the total area of the secondary phase may be 5% to 50%.

By the dielectric composition according to the embodiment, since pore compactness is improved by lowering a sintering temperature of a dielectric, there is an advantage in that dielectric characteristics and moisture resistance reliability of a multilayered capacitor are enhanced.

However, the diverse and beneficial advantages and effects of the present disclosure are not limited to the above-described contents and can be understood more easily in the process of explaining the specific embodiment of the present disclosure.

### BRIEF DESCRIPTION OF THE DRAWINGS

FIG. 1A illustrates an image acquired by observing a dielectric composition according to an embodiment by a transmission electron microscope (TEM).

FIG. 1B illustrates an image acquired by TEM mapping the dielectric composition based on Ga.

FIG. 1C illustrates an image acquired by TEM mapping the dielectric composition based on Si.

FIG. 1D illustrates an image acquired by TEM mapping the dielectric composition based on Al.

FIG. 1E illustrates an image acquired by TEM mapping the dielectric composition based on Mg.

FIG. 2A illustrates an image acquired by TEM mapping the dielectric composition according to an embodiment based on Ga. FIG. 2B is a graph illustrating Ga contents in region 1 and region 2 displayed in FIG. 2A through TEM-EDS analysis.

FIG. 3A illustrates an image acquired by observing the dielectric composition according to an embodiment by the TEM. FIG. 3B illustrates an image displaying an area of a secondary phase included in the dielectric composition. FIG. 3C illustrates an image displaying an area of a second secondary phase included in the dielectric composition.

FIG. 4A illustrates an image acquired by observing the dielectric composition according to an embodiment by an SEM. FIG. 4B is a graph illustrating a content of a constituent ingredient included in the dielectric composition.

FIG. 5 is a graph of analyzing contents of secondary phase constituent ingredients of the dielectric compositions included in multilayered capacitors in Example 1 and Comparative Example 2.

FIG. 6 is a graph illustrating sintering densities for each sintering temperature of dielectric compositions prepared in Preparation Example 1 and Comparative Preparation Examples 1 and 2.

FIG. 7A to 7L illustrate an SEM image illustrating compactness levels of a pore according to a sintering temperature of dielectric components included in the multilayered capacitor in Example 1 and Comparative Examples 1 and 2.

FIG. 8A illustrates an SEM image of a cross-sectional sample of the multilayered capacitor in Example 1. FIG. 8B illustrates an SEM image of a cross-sectional sample of the multilayered capacitor in Comparative Example 1.

FIG. 9 is a graph illustrating dielectric constants for each temperature of the multilayered capacitors in Example 1 and Comparative Examples 1 and 2.

FIGS. 10 to 12 are graphs illustrating evaluation of moisture resistance reliability of the multilayered capacitors in Examples 1 and Comparative Examples 1 and 2, respectively.

FIG. 13 is a perspective view illustrating a multilayered capacitor according to an embodiment.

FIG. 14 is a cross-sectional view of a multilayered capacitor taken along line I-I′ of FIG. 13.

FIG. 15 is an exploded perspective view illustrating a lamination structure of an internal electrode layer in a capacitor body of FIG. 13.

### DETAILED DESCRIPTION

Hereinafter, embodiments of the present disclosure will be described so as to be easily implemented by those skilled in the art, with reference to the accompanying drawings. The drawings and description are to be regarded as illustrative in nature and not restrictive. Like reference numerals designate like elements throughout the specification. Further, the accompanying drawings are provided for helping to easily understand embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure. Further, some constituent elements in the drawing may be exaggerated, omitted, or schematically illustrated, and a size of each constituent element does not reflect the actual size entirely.

In addition, unless explicitly described to the contrary, the word “comprise”, and variations such as “comprises” or “comprising”, will be understood to imply the inclusion of stated elements but not the exclusion of any other elements.

Throughout the specification, ‘lamination direction’ may be a direction in which components are sequentially laminated, and also be a ‘thickness direction’ perpendicular to wide sides (main sides) of components on a sheet, and corresponds to a T-axis direction in the drawing. In addition, ‘side’ is a direction extended in line with the wide side (main side) from a peripheral of the component on the sheet, and may be a ‘plane direction’, and corresponds to an L-axis direction in the drawing. In addition, a W-axis direction in the drawing may be a ‘width direction’.

Hereinafter, modified examples of various examples will be described with reference to drawings.

### Dielectric Composition

The dielectric composition includes dielectric grains containing a barium titanate-based compound, and secondary phases located between the dielectric grains, and the secondary phase includes a first secondary phase including Ga and Si.

As an example, the dielectric grains containing the barium titanate-based compound may be primary phases in which an average area of a total area of the dielectric composition is 85% or more.

As an example, the secondary phase may further include a second secondary phase which does not include (is free of) Ga and includes Si.

The dielectric composition according to an embodiment includes the first secondary phase to serve to reduce a sintering temperature when sintering the dielectric composition and improves the pore compactness to enhance dielectric characteristics and reliability of the multilayered capacitor containing the dielectric composition.

The primary phase is a concept distinguished from the secondary phase and may mean a main phase constituting the dielectric composition, which is generated in the process of sintering a capacitor body 110.

The primary phase may include a main ingredient and a sub ingredient.

The main ingredient as a base material of the dielectric has a high dielectric constant and contributes to forming a dielectric constant of the multilayered capacitor 100.

As an example, the main ingredient as a barium titanate based material, and as an example, may be a dielectric material containing BaₘTiO₃ (0.995≤m≤1.010), (Ba_{1-X}Caₓ)ₘ(Ti_{1-y}Zr_{y})O₃ (0.995≤m≤1.010, 0≤x≤0.10, 0<y≤0.20), Baₘ(Ti₁₋ₓZrₓ)O₃ (0.995≤m≤1.010, x≤0.10), (Ba_{1-X}Caₓ)ₘ(Ti_{1-y}Sn_{y})O₃ (0.995≤m≤1.010, 0≤x≤0.10, 0<y≤0.20), or a combination thereof.

As an example, the main ingredient may include BaTiO₃, Ba(Ti, Zr)O₃, Ba(Ti, Sn)O₃, (Ba, Ca)TiO₃, (Ba, Ca)(Ti, Zr)O₃, (Ba, Ca)(Ti, Sn)O₃, (Ba, Sr)TiO₃, (Ba, Sr)(Ti, Zr)O₃, (Ba, Sr)(Ti, Sn)O₃, or a combination thereof.

As an example, the sub ingredient may include dysprosium (Dy), vanadium (V), manganese (Mn), chromium (Cr), silicone (Si), aluminum (Al), magnesium (Mg), tin (Sn), antimony (Sb), germanium (Ge), gallium (Ga), indium (In), barium (Ba), lanthanum (La), yttrium (Y), actinum (Ac), cerium (Cc), praseodymium (Pr), neodium (Nd), promethium (Pm), samarium (Sm), europium (Eu), gadolinium (Gd), terbium (Tb), holmium (Ho), erbium (Er), thulium (Tm), ytterbium (Yb), lutetium (Lu), hafnium (Hf), or a combination thereof.

As an example, the dielectric composition may include a plurality of dielectric grains, and
the dielectric grains may be the primary phase, and at least one of the plurality of dielectric grains may have a core-shell structure.

The dielectric grain having the core-shell structure includes a dielectric core in one dielectric grain and a shell surrounding at least a part of the core.

The core and the shell may have different molar ratios of the sub ingredient to the main component, and for example, the molar ratio of the sub ingredient to the main ingredient may be rapidly changed on a boundary of the core and the shell. As a result, the boundary of the core and the shell may be easily distinguished, and this may be confirmed through transmission electron microscope-energy dispersive X-ray spectroscopy (TEM-EDS).

As an example, in the core, the sub ingredient is not present or even though the ingredient is present, only a small quantity of sub ingredients may be present. Therefore, the core may be made of a pure main ingredient without containing impurities, and the pure main component may generally have a higher dielectric constant than a main ingredient in which impurities elements are doped. As a result, the core may play a role having the dielectric constant.

The shell includes more sub ingredients than the core. A sub ingredient doped the B-site of a main ingredient (perovskite ABO₃ structure) in the shell has an effect of increasing band gap energy in which other rare earth elements and doping elements are dispersed into the dielectric grain. Accordingly, the sub ingredient may serve as a barrier to inhibit the dispersion of other rare earth elements and doping elements into the dielectric grain. The shell serves to inhibit the dielectric grain from being grown to contribute to granulation of the dielectric grain. Further, a sub ingredient doped in A-site of the main ingredient in the shell may serve to enhance the reliability and the dielectric constant.

The secondary phase may mean ‘secondary phase’, and mean a new phase precipitated after sintering the capacitor body 11.

The secondary phase may be positioned between dielectric grains containing the barium titanate-based compound which constitutes the primary phase.

The secondary phase may include a first secondary phase, and further include a second secondary phase.

The first secondary phase may include Ga and Si, and further include Al or Mg.

As an example, the first secondary phase may include Ga, Si, Al, Mg, and a combination thereof, and as a specific example, the first secondary phase may be a Ga-composite form in which Ga, Si, Al, and Mg are chemically combined.

The second secondary phase may contain Si without containing Ga. The second secondary phase may include Si, and further include Al or Mg. The second secondary phase may be an Si-compound, or an Si-composite form in which Si, Al, and Mg are chemically combined.

The first secondary phase or the second secondary phase may further Ti, V, Mn, Ba, or a combination thereof.

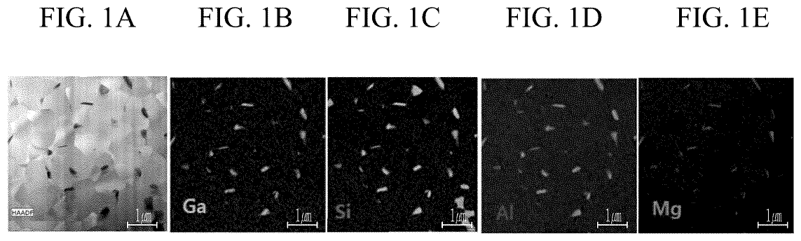

FIG. 1A illustrates an image acquired by observing a dielectric composition according to an embodiment by a transmission electron microscope (TEM). FIG. 1B illustrates an image acquired by TEM mapping the dielectric composition based on Ga. FIG. 1C illustrates an image acquired by TEM mapping the dielectric composition based on Si. FIG. 1D illustrates an image acquired by TEM mapping the dielectric composition based on Al. FIG. 1E illustrates an image acquired by TEM mapping the dielectric composition based on Mg.

Referring to FIG. 1A, by a method such as binarizing the TEM image, parts having a brightness difference are distinguished to distinguish the primary phase and the secondary phase, and a relatively dark region may correspond to the secondary phase. As an example, the secondary phase may be positioned outside the dielectric grains of the primary phase, and for example, the secondary phase may be positioned on a boundary between the dielectric grains of the primary phase.

Referring to FIGS. 1B to 1E, the light grey regions indicate the presence of the element of interest, the secondary phase containing Ga may be defined as the first secondary phase, and it can be seen that Si, Al, and Mg are compounded with the first secondary phase. Further, referring to FIGS. 1B and 1C, among the secondary phases containing Si, a secondary phase not containing Ga may be defined as the second secondary phase.

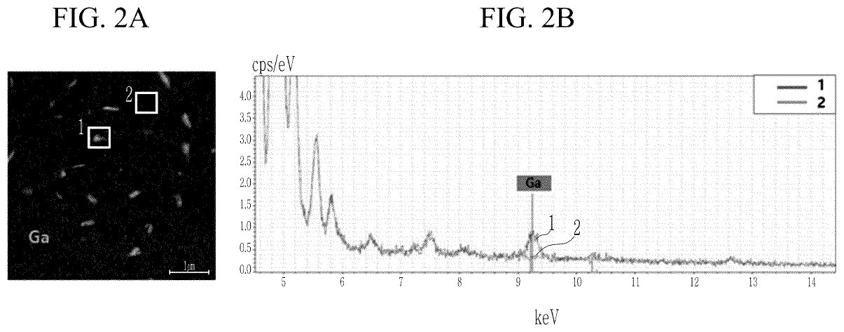

FIG. 2A illustrates an image acquired by TEM mapping the dielectric composition according to an embodiment based on Ga, and region 1 displayed in the image means the first secondary phase and region 2 displayed in the image means the second secondary phase.

FIG. 2B is a graph illustrating Ga contents in region 1 and region 2 displayed in FIG. 2A through TEM-EDS analysis.

Referring to FIG. 2B, it can be seen that Ga is contained in the first secondary phase, while Ga is not contained in the second secondary phase.

In an embodiment, the first secondary phase may contain the Si in an amount of 1.0 part by mol to 3.0 parts by mol, with respect to 1 part by mol of Ga, and for example, may contain 1.5 parts by mol to 3.0 parts by mol, or 1.5 parts by mol to 2.5 parts by mol.

In an embodiment, the first secondary phase may contain the Al in an amount of 0.5 parts by mol to 2.5 parts by mol, with respect to 1 part by mol of Ga, and for example, may contain 1.0 parts by mol to 2.5 parts by mol, or 1.0 parts by mol to 2.0 parts by mol.

In an embodiment, the first secondary phase may contain the Mg in an amount of 0.2 parts by mol to 1.2 parts by mol, with respect to 1 part by mol of Ga, and for example, may contain 0.2 parts by mol to 1.0 mol, or 0.4 parts by mol to 1.0 mol.

When the content of the constituent element contained in the first secondary phase satisfies the numerical range, the sintering temperature of the dielectric composition is sufficiently lowered to significantly improve the pore compactness.

In the multilayered capacitor 100, the content (mol) of the constituent element included in the first secondary phase may be obtained in the following method.

The multilayered capacitor 100 according to an embodiment is put and cured in an epoxy mixture liquid, and then L-axis direction and T-axis direction sides of the capacitor body 110 are polished up to 1% in a W-axis direction, and fixed, and kept in a vacuum atmosphere, and cut in an L-axis direction and a T-axis direction at the center in the W-axis direction of the capacitor body 110 to prepare a cross-sectional sample.

Then, an arbitrary dielectric layer positioned in an active region, or a cover region of the cross-sectional sample is selected, and then a transmission electron microscope (TEM) image is obtained in a region of 5 μm×5 μm (unit area).

With respect to the TEM image, a mapping image for each element for Ga, Si, Al, and Mg is obtained by using Transmission Electron Microscope-Energy Dispersive X-ray Spectroscopy (TEM-EDS), and then an arbitrary first secondary phase containing Ga is selected to conduct a content analysis for each element. After the content of each element is measured as mol, the contents (mols) of Ga, Si, Al, and Mg may be represented as relative values based on 1 mol of Ga. Other methods and/or tools appreciated by one of ordinary skill in the art, even if not described in the present disclosure, may also be used.

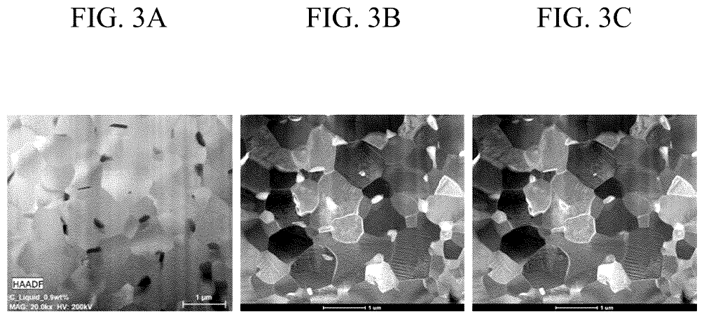

FIG. 3A illustrates an image acquired by observing the dielectric composition according to an embodiment by the TEM. FIG. 3B illustrates an image displaying an entire area of a secondary phase included in the dielectric composition. FIG. 3C illustrates an image displaying an area of a second secondary phase included in the dielectric composition.

Referring to FIGS. 3A to 3C, the dielectric grains containing the barium titanate-based compound may be a primary phase in which an average area to the total area of the dielectric composition is 85% or more, and in the secondary phase, the average area to the total area of the dielectric composition is 15% or less.

Referring to FIGS. 3A to 3C, an average area (%) occupied by the first secondary phase with respect to the area (e.g., a total area) of the secondary phase may be 50% to 95%, and for example, may be 50% to 90%, or 50% to 80%.

An average area (%) occupied by the second secondary phase with respect to the area (e.g., a total area) of the secondary phase may be 5% to 50%, and for example, may be 10% to 50%, or 20% to 50%.

A ratio of the average area of the first secondary phase with respect to the total area of the secondary phase to the average area of the second secondary phase to the total area of the secondary phase may be 1.5 to 2.5.

When the average areas (%) occupied by the first secondary phase and the second secondary phase with respect to all secondary phases, and the ratio of the average area satisfy the numerical ranges, the sintering temperature of the dielectric composition is sufficiently lowered to significantly improve the pre compactness.

In the multilayered capacitor 100 according to an embodiment, a method for obtaining the average areas (%) of the primary phase and the secondary phase to the area of the dielectric composition, the average areas (%) occupied by the first secondary phase and the second secondary phase with respect to the secondary phase, and the ratio of the average areas is described below.

First, the cross-sectional sample of the multilayered capacitor described above is prepared, an arbitrary dielectric layer positioned in the active region or cover region of the cross-sectional sample is selected, and then a transmission electron microscope (TEM) image is obtained in a region of 5 μm×5 μm. Thereafter, the areas of the primary phase and the secondary phase, and the areas of the first secondary phase and the second secondary phase included in the secondary phase may be measured by using an image analysis program. Further, an arithmetic average of values measured in three or more regions having the size of 5 μm×5 μm is obtained to obtain the average areas of the primary phase and the secondary phase, and the average areas (%) occupied by the first secondary phase and the second secondary phase with respect to all secondary phases. Furthermore, the ratio between the average areas (%) of the first secondary phase and the second secondary phase described above may be obtained. Other methods and/or tools appreciated by one of ordinary skill in the art, even if not described in the present disclosure, may also be used.

In an embodiment, the content of the Ga may be 0.1 wt % to 1.0 wt %, based on, for example, a total weight of all the components of the dielectric composition. For example, the content of the Ga may be 0.1 wt % to 0.5 wt %, based on, for example, a total weight of all the components of the dielectric composition.

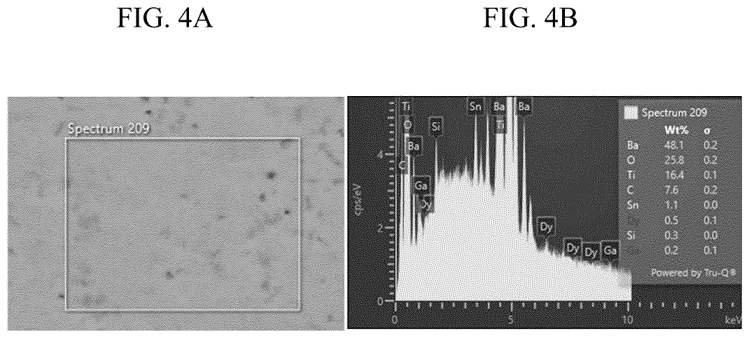

FIG. 4A illustrates an image acquired by observing the dielectric composition according to an embodiment by an SEM. FIG. 4B is a graph illustrating a content of a constituent ingredient included in the dielectric composition.

Referring to FIGS. 4A and 4B, an arbitrary dielectric layer positioned in the active region or cover region of the cross-sectional sample may be selected, and then a scanning electron microscope (SEM) image may be obtained, and the content of Ga to the entire dielectric composition may be measured through Scanning Electron Microscope-Energy Dispersive X-ray Spectroscopy (SEM-EDS) ingredient analysis.

### Multilayered Capacitor

The multilayered capacitor 100 according to an embodiment includes a capacitor body 110 including a dielectric layer 111 and internal electrodes 121 and 122, and external electrodes 131 and 132 disposed outside the capacitor body 110, and the dielectric layer 111 contains the dielectric composition.

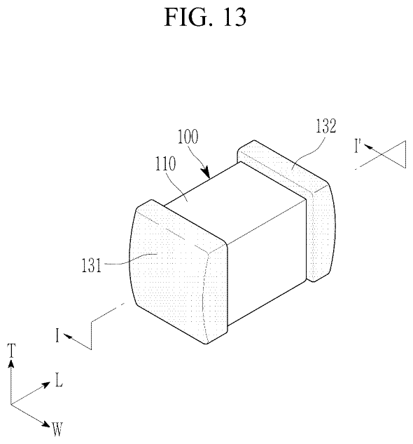

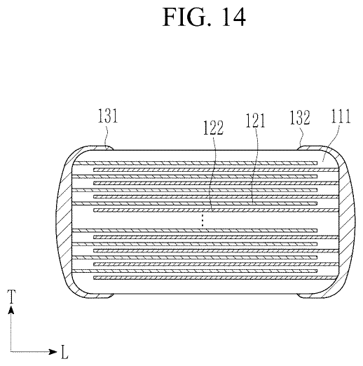

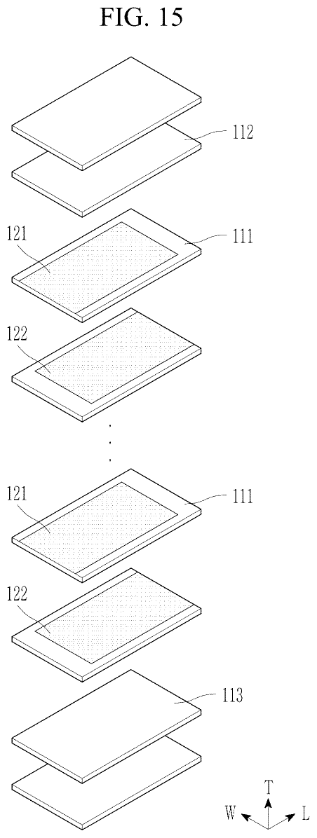

FIG. 13 is a perspective view illustrating a multilayered capacitor according to an embodiment, FIG. 14 is a cross-sectional view of a multilayered capacitor taken along line I-I′ of FIG. 13, and FIG. 15 is an exploded perspective view illustrating a lamination structure of an internal electrode layer in a capacitor body of FIG. 13.

When the direction is defined to clearly explain the present embodiment, an L axis, a W axis, and a T axis indicate a longitudinal direction, a width direction, and a thickness direction of the capacitor body 110, respectively. Here, the thickness direction (T-axis direction) may be a perpendicular direction on wide sides (main sides) of sheet-shaped components, and as an example, may be used as the same concept as a lamination direction in which the dielectric layer 111 is laminated. The longitudinal direction (L-axis direction) as a direction extended in line with the wide sides (main sides) of the sheet-shaped components may be a direction substantially perpendicular to the thickness direction (T-axis direction), and as an example, may be a direction in which the first external electrode 131 and the second external electrode 132 are positioned at both sides. The width direction (W-axis direction) as a direction extended in line with the wide sides (main sides) of the sheet-shaped components may be a direction substantially perpendicular to the thickness direction (T-axis direction) and the longitudinal direction (L-axis direction), and lengths in the longitudinal direction (L-axis direction) of the sheet-shaped components may be longer than lengths in the width direction (W-axis direction).

Referring to FIGS. 13 to 15, the multilayered capacitor 100 according to an embodiment may include a capacitor body 110, and a first external electrode 131 and a second external electrode 132 disposed both ends facing each other in the longitudinal direction (L-axis direction) of the capacitor body 110.

The capacitor body 110 may have, as an example, an approximately hexahedral shape.

In the embodiment, for convenience of description, both surfaces facing each other in the thickness direction (T-axis direction) in the capacitor body 110 will be defined as a first surface and a second surface, both surfaces connected to the first surface and the second surface, and facing each other in the longitudinal direction (L-axis direction) will be defined as a third surface and a fourth surface, and both surfaces connected to the third surface and the fourth surface, and facing each other in the width direction (W-axis direction) will be defined as a fifth surface and a sixth surface.

As an example, the first surface which is a bottom surface may be a surface facing a mounting direction. Further, the first to sixth surfaces may be flat, but the embodiment is not limited thereto, and for example, the first to sixth surfaces may be curved surfaces in which a center portion is convex, and an edge of each surface may be rounded.

A shape and a dimension of the capacitor body 110, and the number of laminated dielectric layers 111 are not limited to those illustrated in the drawings of the embodiments.

The capacitor body 110 may be obtained by laminating a plurality of dielectric layers 111 in the thickness direction (T-axis direction) and sintering the dielectric layers 111 includes a plurality of dielectric layers 111, and a first internal electrode layer 121 and a second internal electrode layer 122 disposed alternatively in the thickness direction (T-axis direction) with the dielectric layer 111 interposed therebetween.

In this case, boundaries between respective dielectric layers 111 adjacent to each other in the capacitor body 110 may be integrated so that it is difficult to confirm the boundaries without using a scanning electron microscope (SEM).

Further, the capacitor body 110 may include an active region and cover regions 112 and 113.

The active region is a part which contributes to forming a capacity of the multilayered capacitor 100. As an example, the active region may be a region in which the first internal electrode 121 or the second internal electrode 122 laminated in the thickness direction (T-axis direction) may be overlapped.

The cover regions 112 and 113 as thickness-direction margin portions may be positioned on the first surface and the second surface of the active region, respectively in the thickness direction (T-axis direction). In the cover regions 112 and 113, a single dielectric layer 111 or two or more dielectric layers 111 may be laminated on atop surface and a bottom surface of the active region, respectively.

Further, the capacitor body 110 may include side cover regions. The side cover regions as thickness-direction margin portions may be positioned on the fifth surface and the sixth surface of the active region, respectively in the width direction (W-axis direction). The side cover regions may be formed by applying, when a conductive paste layer for forming an internal electrode layer is applied to a dielectric green sheet surface, the conductive paste layer only to a part of the dielectric green sheet surface, and laminating dielectric green sheets to which the conductive paste layer is not applied on both sides of the dielectric green sheet surface, and sintering the dielectric green sheets.

The cover regions 112 and 113, and the side cover regions serve to prevent the first internal electrode layer 121 and the second internal electrode layer 122 from being damaged due to physical or chemical stress.

The dielectric layer 111 includes the dielectric composition according to an embodiment described above. As a result, the dielectric layer 111 having the improved pore compactness is included to implement the multilayered capacitor 100 having enhanced dielectric feature and moisture resistance reliability. The dielectric composition is described in detail, so here, the description is omitted.

As an example, an average thickness of the dielectric layer 111 may be 0.05 μm or more and 0.1 μm or more, or may be 0.5 μm or more, and may be 10 μm or less, 5 μm or less, or 2.5 μm or less.

The average thickness of the dielectric layer 111 may be an arithmetic average value of the thicknesses of the dielectric layer 111 at 10 points spaced apart from a reference point by a predetermined interval by setting a center point in the longitudinal direction (L-axis direction) or the width direction (W-axis direction) of the dielectric layer 111 as the reference point in the SEM image of the cross-sectional sample. The intervals of the 10 points may be controlled according to a scale of the SEM image, and may be intervals of, for example, 1 μm to 100 μm, 1 μm to 50 μm, or 1 μm to 10 μm. In this case, when all of the 10 points should be positioned in the dielectric layer 111, and all of the 10 points are not positioned in the dielectric layer 111, a location of the reference point may be changed or the intervals between 10 points may be controlled.

The first internal electrode 121 and the second internal electrode 122 as electrodes having different polarities are disposed alternatively to face each other in the T-axis direction with the dielectric layer 111, and one end may be exposed through each of the third surface and the fourth surface of the capacitor body 110.

The first internal electrode 121 and the second internal electrode 122 may be electrically insulated from each other by the dielectric layer 111 disposed in the middle of the first internal electrode 121 and the second internal electrode 122.

Ends of the first internal electrode 121 and the second internal electrode 122 exposed alternatively through the third and fourth surfaces of the capacitor body 110 may be connected, and electrically connected to the first external electrode 131 and the second external electrode 132, respectively.

The first internal electrode 121 and the second internal electrode 122 may include conductive metal, and for example, may include metal such as Ni, Cu, Ag, Pd, or Au or an alloy thereof, for example, Ag—Pd alloy.

Further, the first internal electrode 121 and the second internal electrode 122 may also include a dielectric particle of the same composition as a ceramic material included in the dielectric layer 111.

The first internal electrode 121 and the second internal electrode 122 may be formed by using a conductive paste including the conductive metal. A printing method of the conductive paste may adopt a screen-printing method or a gravure printing method.

As an example, average thicknesses of the first internal electrode 121 and the second internal electrode 122 may be 0.05 μm or more, 0.1 μm or more, 0.2 μm, or 0.25 μm or more, and may be 2.5 μm or less, 1 μm, or 0.5 μm or less.

The average thickness of the first internal electrode 121 or the second internal electrode 122 may be an arithmetic average value of the thicknesses of the first internal electrode 121 or the second internal electrode 122 at 10 points spaced apart from a reference point by a predetermined interval by setting a center point in the longitudinal direction (L-axis direction) or the width direction (W-axis direction) of the first internal electrode 121 or the second internal electrode 122 as the reference point in the SEM image of the cross-sectional sample. Intervals of 10 points may be controlled according to a scale of the SEM image, and may be intervals of, for example, 1 μm to 100 μm, 1 μm to 50 μm, or 1 μm to 10 μm. In this case, when all of the 10 points should be positioned in the first internal electrode 121 or the second internal electrode 122, and all of the 10 points are not positioned in the first internal electrode 121 or the second internal electrode 122, a location of the reference point may be changed or the intervals between 10 points may be controlled.

Voltages having different polarities may be provided to the first external electrode 131 and the second external electrode 132, and exposed parts of the first external electrode 131 and the second external electrode 132 may be connected and electrically connected to each other.

According to such a configuration, when a predetermined voltage is applied to the first external electrode 131 and the second external electrode 132, charges are accumulated between the first internal electrode 121 and the second internal electrode 122 facing each other. In this case, a capacitance of the multilayered capacitor 100 is in proportion to an overlapped area of the first internal electrode 121 and the second internal electrode 122 overlapped with each other in the T-axis direction in the active region.

The first external electrode 131 and the second external electrode 132 may include first and second connection portions disposed on the third surface and the fourth surface of the capacitor body 110, respectively, and connected to the first internal electrode 121 and the second internal electrode 122, and first and second band portions disposed at corners at which the third and fourth surfaces of the capacitor body 110, and the first and second surfaces or the fifth and sixth surfaces meet, respectively.

The first and second band portions may be extended up to parts of the first and second surfaces or the fifth and sixth surfaces of the capacitor body 110, respectively at the first and second connection portions. The first and second band portions may serve to enhance fixation strengths of the first external electrode 131 and the second external electrode 132.

As an example, each of the first external electrode 131 and the second external electrode 132 may include a sintering metal layer which is in contact with the capacitor body 110, a plating layer disposed to cover the conductive resin layer.

The sintering metal layer may include conductive metal and glass.

As an example, the sintering metal layer may include copper (Cu), nickel (Ni), silver (Ag), palladium (Pd), gold (Au), platinum (Pt), tin (Sn), tungsten (W), titanium (Ti), lead (Pb) as conductive metal, alloys thereof, or combinations thereof, and for example, copper (Cu) may include a copper (Cu) alloy. When the conductive metal includes copper, metal other than copper may include 5 parts by mol with respect to copper of 100 parts by mol.

As an example, the sintering metal layer may include a composition in which oxides are mixed as the glass, and may be, for example, at least one selected from the group consisting of silicon oxide, boron oxide, aluminum oxide, transition metal oxide, alkaline metal oxide, and alkaline earth metal oxide. The transition metal may be at least one selected from the group consisting of zinc (Zn), titanium (Ti), copper (Cu), vanadium (V), manganese (Mn), iron (Fe) and nickel (NI), the alkaline metal may be at least one selected from the group consisting of lithium (Li), sodium (Na), and potassium (K), and the alkaline earth metal may be at least one selected from the group consisting of magnesium (Mg), calcium (Ca), strontium (Sr), and barium (Ba).

Optionally, the conductive resin layer may be formed on the sintering metal layer, and for example, formed in a form of fully covering the sintering metal layer. Meanwhile, the first external electrode 131 and the second external electrode 132 may not include the sintering metal layer, and in this case, the conductive resin layer may be in direct contact with the capacitor body 110.

The conductive resin layer may be extended to the first and second surfaces or the fifth and sixth surfaces of the capacitor body 110, and a length of a region (i.e., a band portion) in which the conductive resin layer is extended and disposed onto the first and second surfaces, or the fifth and sixth surfaces of the capacitor body 110 may be longer than a length of a region (i.e., band portion) in which the sintering metal layer is extended and disposed onto the first and second surfaces, or the fifth and sixth surfaces of the capacitor body 110. That is, the conductive resin layer may be formed on the sintering metal layer, and for example, formed in a form of fully covering the sintering metal layer.

The conductive resin layer includes a resin and conductive metal.

If the resin included in the conductive resin layer is a resin which may have a bonding property and a shock absorption property, the resin is not particularly limited, and for example, may include phenolic resin, acrylic resin, silicone resin, epoxy resin, or polyimide resin.

The conductive metal included in the conductive resin layer serves to be electrically connected the first internal electrode 121 and the second internal electrode 122, or the sintering metal layer.

The conductive metal included in the conductive resin layer may have a spherical form, a flake form, or a combination thereof. That is, the conductive metal may be configured only in the flake form, configured only in the spherical form, and also be a form in which the flake form and the spherical form are mixed.

Here, the spherical form may also include a form other than a fully spherical form, and for example, include a form in which a length ratio (long axis/short axis) of the long axis and the short axis is 1.45 or less. Flake form powder may mean powder having a flat or elongated form, and is not particularly limited, but for example, the length ratio of the long axis/the short axis (long axis/short axis) may be 1.95 or more.

The first external electrode 131 and the second external electrode 132 may further include a conductive layer disposed outside the conductive resin layer.

The plating layer may include nickel (Ni), copper (Cu), tin (Sn), palladium (Pd), platinum (Pt), gold (Au), silver (Ag), tungsten (W), titanium (Ti) or lead (Pb) alone, or an alloy thereof. As an example, the plating layer may be a nickel (Ni) plating layer or a tin (Sn) plating layer, may be a form in which the nickel (Ni) plating layer or the tin (Sn) plating layer are sequentially laminated, and may be a form in which the tin (Sn) plating layer, the nickel (Ni) plating layer, and the tin (Sn) plating layer are sequentially laminated. Further, the plating layer may also include a plurality of nickel (Ni) plating layers and/or a plurality of tin (Sn) plating layers.

The plating layer may improve mountability with a substrate, structural reliability, durability for the outside, heat resistance, and equivalent series resistance (ESR) of the multilayered capacitor 100.

### Manufacturing Method of Multilayered Capacitor

A manufacturing method of the multilayered capacitor according to another embodiment includes a step of manufacturing dielectric powder containing gallium (Ga), a step of manufacturing a capacitor body including a dielectric layer and an internal electrode, and a step of forming an external electrode outside the capacitor body.

First, a method for manufacturing the dielectric powder containing Ga is described.

As an example, Ga is added to a precursor of a barium titanate-based dielectric to prepare a dielectric mixture. The Ga may be added in the form of a fine particle having an average particle diameter of 1 nm to 15 nm, and the Ga may be added in the form of a complex jointly with a phase stabilizer, a surfactant, or a dispersant. The average particle diameter of Ga particles may be determined by, for example, a particle size analyzer. Other methods and/or tools appreciated by one of ordinary skill in the art, even if not described in the present disclosure, may also be used.

The dielectric mixture is uniformly mixed and dried, and then heat-treated to obtain plastic powder, thereby manufacturing the dielectric powder containing Ga.

When the manufactured dielectric powder containing Ga is included in a dielectric paste, and sintered at a temperature of 1000° C. to 1200° C., the Ga having a low melting point may form the first secondary phase jointly with Al, Si, or Mg. Since the first secondary phase serves to lower the sintering temperature, the first secondary phase improves the pore compactness of the dielectric to enhance the dielectric feature and reliability of the capacitor.

Next, manufacturing the capacitor body is described.

In a manufacturing process of the capacitor body, a conductive paste is prepared, which becomes the internal electrode after sintering with the dielectric paste which becomes the dielectric layer after sintering.

The dielectric paste is manufactured by, for example, the following method. The manufactured dielectric powder containing Ga is uniformly mixed by means such as wet mixing, etc., and dried, and then heat-treated under a predetermined condition to obtain the plastic powder. An organic vehicle or an aqueous vehicle is added to the obtained plastic powder, and kneaded, and the dielectric paste is prepared.

The obtained dielectric paste is m″de i′to a sheet by a technique such as a doctor blade method to obtain a dielectric green sheet. Further, the dielectric paste may contain an additive selected from various dispersants, plasticizers, dielectrics, sub ingredient compounds, or glass as needed.

The conductive paste for the internal electrode is prepared by kneading conductive powder made of conductive metal or alloys thereof, and a binder or a solvent. The conductive paste for the internal electrode may contain ceramic powder (e.g., barium titanate powder) as an inhibitor as needed. The inhibitor may serve to inhibit sintering of the conductive powder in a sintering process.

The conductive paste for the internal electrode is applied to the dielectric green sheet surface in a predetermined pattern by various printing methods or transcription methods including screen printing, etc. In addition, a plurality of layers of green sheets with an internal electrode pattern are laminated, and then pressed in a lamination direction to obtain a dielectric green sheet laminate. In this case, the dielectric green sheet and the internal electrode pattern may be laminated so that the dielectric green sheet is positioned on a top surface and a bottom surface in the lamination direction of the dielectric green sheet laminate.

Optionally, the obtained dielectric green sheet laminate may be cut in a predetermined dimension by dicing, etc.

Further, the dielectric green sheet laminate may be solidified and dried in order to remove the plasticizer as needed, and barrel-polished by using a horizontal centrifugal barrel machine after solidifying and drying. In the barrel polishing, the dielectric green sheet laminate is input into a barrel container jointly with media and polishing fluid, and a rotary motion or vibration is granted to the barrel container to polish an unnecessary portion such as a burr generated upon cutting. Further, after the barrel polishing, the dielectric green sheet laminate may be washed with a cleaning solution such as water, and dried.

The dielectric green sheet laminate is subjected to de-binder treatment and sintering treatment to obtain the capacitor body.

A condition for the de-binder treatment may be appropriately controlled according to a main ingredient composition of the dielectric layer or a main ingredient composition of the internal electrode. For example, a heating rate during the de-binder treatment may be 5° C./hour to 300° C./hour, a support temperature may be 180° C. to 400° C., and the temperature may be maintained for 0.5 hours to 24 hours. A de-binder atmosphere may be an air or reducing atmosphere.

A condition for the sintering treatment may be appropriately controlled according to the main ingredient composition of the dielectric layer or the main ingredient composition of the internal electrode.

In respect to the dielectric composition according to an embodiment, the first secondary phase serves to lower the sintering temperature upon sintering the dielectric composition, and as an example, the sintering temperature may be 1000° C. to 1200° C. and may be, for example, 1050° C. to 1200° C., or 1050° C. to 1150° C.

Accordingly, the pore compactness is improved by setting the sintering temperature to a relatively low temperature to implement a capacitor having high reliability.

As an example, a sintering time may be 0.5 hours or 8 hours, or 1 hour to 3 hours. A sintering atmosphere may be a reducing atmosphere, and may be, for example, an atmosphere in which mixed gas of nitrogen gas (N₂) and hydrogen gas (H₂) is humidified. When the internal electrode contains nickel (Ni) or nickel (Ni) alloy, oxygen partial pressure in the sintering atmosphere may be 1.0×10⁻¹⁴ Mpa to 1.0×10⁻¹⁰ Mpa.

After the sintering treatment, annealing may be performed as needed. The annealing is a treatment for reoxidizing the dielectric layer, and when the sintering treatment is performed in the reducing atmosphere, the annealing may be performed. A condition for the annealing treatment may also be appropriately controlled according to the main ingredient composition of the dielectric layer. For example, a temperature upon annealing may be 950° C. to 1150° C., a time may be 0 hour to 20 hours, and the heating rate may be 50° C./hour to 500° C./hour. The annealing atmosphere may be a humidified nitrogen gas (N₂) atmosphere, and the oxygen partial pressure may be 1.0×10⁻⁹ Mpa to 1.0×10⁻⁵ Mpa.

In the de-binder treatment, the sintering treatment, or the annealing treatment, for example, water may be used in order to humidify the nitrogen gas or the mixed gas, and in this case, a water temperature may be 5° C. to 75° C. The de-binder treatment, the sintering treatment, and the annealing treatment may be continuously performed, and also performed independently.

Optionally, a surface treatment such as sand blasting treatment, laser irradiation, or barrel polishing may be performed with respect to the third and fourth surfaces of the obtained capacitor body. By performing the surface treatment, the ends of the first and second internal electrodes may be exposed to an outermost surface, and as a result, electrical bonding between the first external electrode and the second external electrode, and the first internal electrode and the second internal electrode may become excellent, and an alloy part may be easily formed.

A sintering metal layer forming paste as the external electrode is applied onto an outer surface of the obtained capacitor body, and then sintered to form the sintering metal layer.

The sintering metal layer forming paste may include conductive metal and glass. The description of the conductive metal and glass is the same as the above description, so a redundant description is omitted. Further, the sintering metal layer forming paste may optionally contain a sub ingredient such as binder, solvent, the dispersant, plasticizer, or oxide power. For example, the binder may adopt ethylcellulose, acryl, or butyral, and the solvent may adopt organic solvents such as terpineol, butyl carbitol, alcohol, methyl ethylketone, acetone, or toluene, or aqueous solvents.

A method for applying the sintering metal layer forming paste onto the outer surface of the capacitor body may adopt a dip method, various printing methods such as screen printing, an application method using a dispenser, etc., or a spray method using a spray. The sintering metal layer forming paste may be applied at least to the third and fourth surfaces of the capacitor body, and also optimally applied to a part of a first surface, a second surface, a fifth surface, or a sixth surface in which the bands portions of the first external electrode and the second external electrode are formed.

Thereafter, the capacitor body to which the sintering metal layer forming paste is applied is dried and sintered at a temperature of 700° C. to 1000° C. for 0.1 hour to 3 hours to form the sintering metal layer.

Optionally, a conductive resin layer forming paste is applied, and cured onto the outer surface of the obtained capacitor body to form the conductive resin layer.

The conductive resin layer forming paste may include the resin, and optimally include the conductive metal or a non-conductive filler. The description of the conductive metal and resin is the same as the above description, so a redundant description is omitted. Further, the conductive resin layer forming paste may optionally contain a sub ingredient such as binder, solvent, the dispersant, plasticizer, or oxide power. For example, the binder may adopt ethylcellulose, acryl, or butyral, and the solvent may adopt organic solvents such as terpineol, butyl carbitol, alcohol, methyl ethylketone, acetone, or toluene, or aqueous solvents.

As an example, in the method for forming the conductive resin layer, the capacitor body 110 is dipped into the conductive resin layer forming paste, and cured, or the conductive resin layer forming paste is printed onto the surface of the capacitor body 110 by the screen printing method or the gravure printing method, or the conductive resin layer forming paste is applied to the surface of the capacitor body 110, and cured to form the conductive resin layer.

Next, the plating layer is formed outside the conductive resin layer.

As an example, the plating layer may be formed by a plating method, and also formed by sputter or electric deposition.

Hereinafter, specific examples of the present disclosure are provided. However, examples disclosed below are only to exemplify or describe the present disclosure in detail, so the scope of the present disclosure should not be limited.

### EXAMPLES

### Preparation Example: Preparation of Dielectric Composition

### Preparation Example 1

First, a mixture in which Ga (particle size: 5 nm), surfactant, and phase stabilizer were mixed was dispersed into an ethanol solvent. BaTiO₃ was added to the dispersed mixture, and a dielectric mixture was prepared to include Ga (particle size: 5 nm) in an amount of 0.9 mols based on 100 parts by mol of BaTiO₃. The dielectric mixture was uniformly mixed and dried, and then heat-treated to obtain plastic powder, thereby manufacturing dielectric powder containing gallium (Ga) according to Preparation Example 1.

### Comparative Preparation Example 1

Except that the Ga was not added, dielectric powder without gallium (Ga) according to Comparative Preparation Example 1 was prepared in the same method as Preparation Example 1 above.

### Comparative Preparation Example 2

Except that oxide-type Ga having a particle size of 500 nm was added, dielectric powder containing gallium (Ga) according to Comparative Preparation Example 2 was prepared in the same method as Preparation Example 1 above.

### Example: Manufacturing Multilayered Capacitor

Ethanol, toluene, dispersant, and binder were mixed with the dielectric power containing gallium (Ga) prepared in Preparation Example 1 and Comparative Preparation Examples 1 and 2, and then mechanically milled to prepare dielectric slurry.

A dielectric green sheet was prepared with the prepared dielectric slurry by using a head ejection type on roll coater.

A conductive paste layer containing nickel (Ni) was printed on a dielectric green sheet surface, and a dielectric green sheet (width×length×height=3.2 mm×2.5 mm×2.5 mm) with the conductive paste layer was laminated and compressed to prepare a dielectric green sheet laminate.

The dielectric green sheet laminate was subjected to a plastic process under a nitrogen atmosphere at 400° C. or less and fired under a condition in which a sintering temperature was 1100° C. and a hydrogen concentration was 1.0% H₂ or less to prepare a capacitor body, and then an external electrode was formed outside the capacitor body to prepare the multilayered capacitors in Example 1 and Comparative Examples 1 and 2.

### Evaluation Example

### Evaluation Example 1: Analysis of Content of Constituent Elements of Secondary Phase Containing Ga

The multilayered capacitor 1 in Example 1 and Comparative Example 2 was put and cured in an epoxy mixture liquid, and then sides of the capacitor body facing the L-axis direction and T-axis direction were polished up to 1% in a W-axis direction, and fixed, and kept in a vacuum atmosphere, and cut in an L-axis direction and a T-axis direction at the center in the W-axis direction of the capacitor body to prepare a cross-sectional sample.

Then, an arbitrary dielectric layer positioned in an active region, or a cover region of the cross-sectional sample is selected, and then a transmission electron microscope (TEM) image was obtained in a region of 5 μm×5 μm. For reference the secondary phase may correspond to a relatively dark region in the TEM image.

A mapping image for Ga was obtained from the TEM image, and then an arbitrary first secondary phase containing Ga was selected to obtain the contents (mols) of Si, Al, and Mg, based on 1 mol of Ga, by using TEM-EDS.

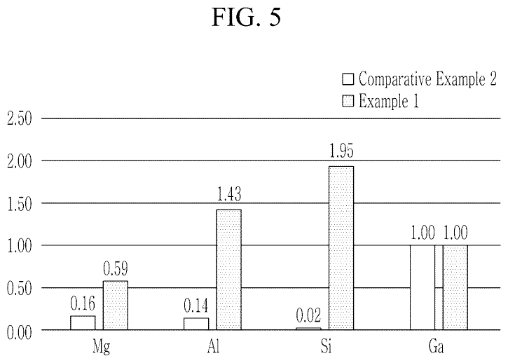

FIG. 5 is a graph of the contents of secondary phase constituent ingredients of the dielectric compositions included in multilayered capacitors in Example 1 and Comparative Example 2.

Referring to FIG. 5, it can be seen that in the case of Example, the secondary phase containing Ga contains Si 1.95 mols, Al 1.43 moles, and Mg 0.59 mols, based on 1 mol of Ga.

On the contrary, it can be seen that in the case of Comparative Example 2, Si, Al, and Mg are contained in a very small amount as compared with Ga, so the secondary phase containing Ga is not compounded with other elements, and Ga is present alone.

### Evaluation Example 2: Evaluation of Sintering Density and Pore Compactness

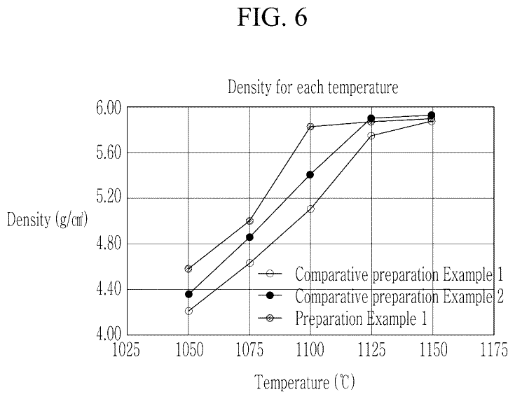

FIG. 6 is a graph illustrating sintering densities for each sintering temperature of dielectric compositions prepared in Preparation Example 1 and Comparative Preparation Examples 1 and 2.

Specifically, the dielectric composition prepared in Preparation Example 1 and Comparative Examples 1 and 2 was prepared as a cube (K2 Bulk) sample, and then the pellet was sintered at a temperature of 1050° C. to 1150° C. for 90 minutes to measure a change in density (g/cm³) of the sample. In this case, when the density reached 5.7 g/cm³ to 5.8 g/cm³, the pore compactness was ensured, so it was determined that sintering was completed.

Referring to FIG. 6, it can be seen that in the case of Preparation Example 1, the sintering density is reached before 1100° C., while it can be seen that in the case of Comparative Examples 1 and 2, the sintering density is reached at approximately 1125° C. Therefore, it can be seen that sintering the dielectric composition in Preparation Example 1 was completed at a relatively low temperature.

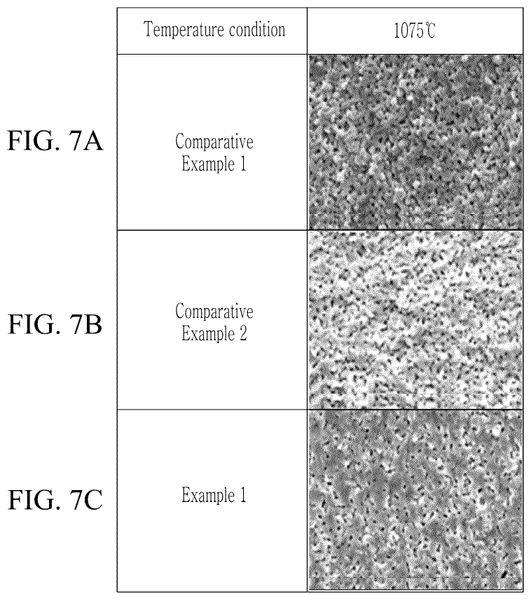

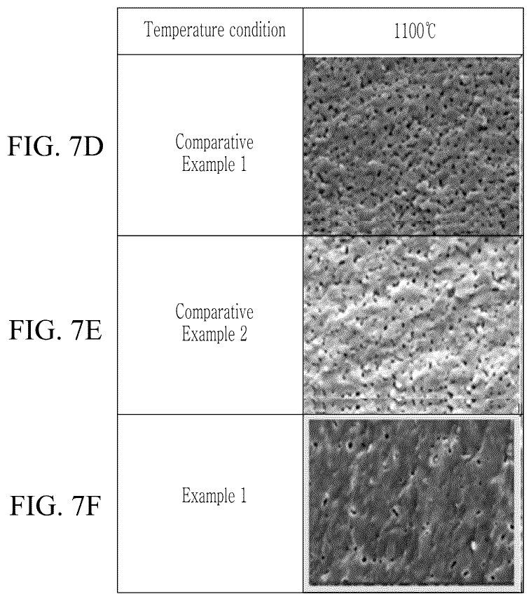

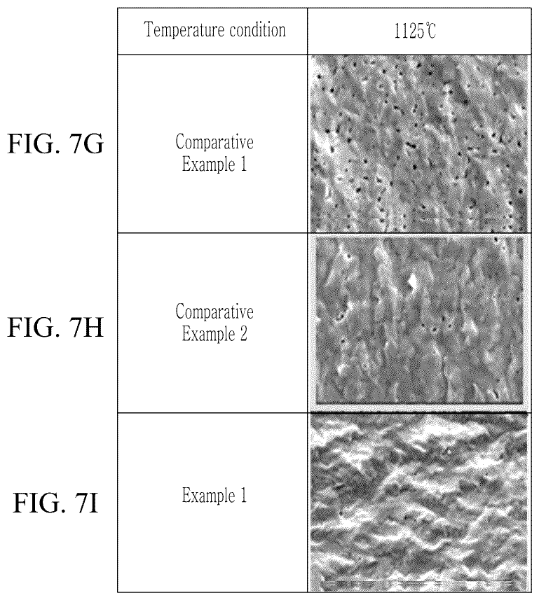

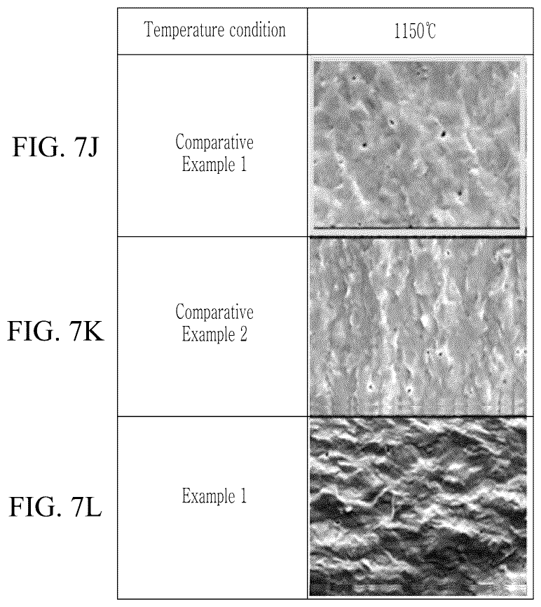

FIG. 7A to 7L illustrate an SEM image illustrating pore compactness levels according to a sintering temperature of dielectric components included in the multilayered capacitor in Example 1 and Comparative Examples 1 and 2. The SEM image may be an image in which an arbitrary dielectric layer positioned in an active region or a cover region of the cross-sectional sample of the multilayered capacitor is selected, and then a transmission electron microscope (TEM) image is obtained in a region of 5 μm×5 μm.

Referring to FIG. 7A to 7L, it can be seen that in the case of Example 1, the pore compactness is ensured at 1100° C., while the pore compactness is ensured at 1150° C. in the case of Comparative Example 1 and at 1125° C. in the case of Comparative Example 2.

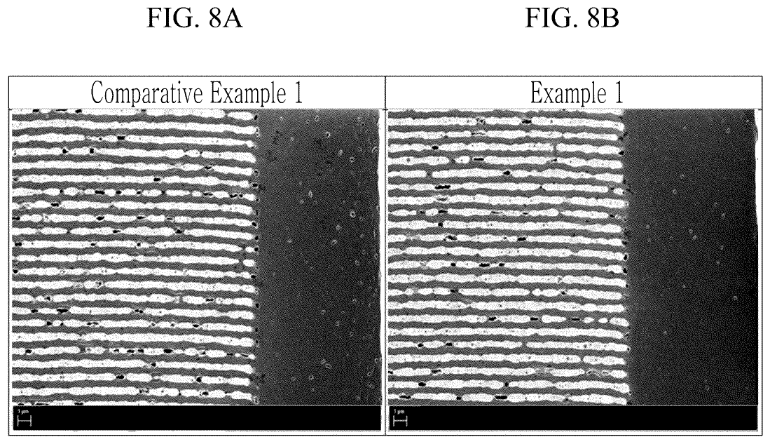

FIG. 8A illustrates an SEM image of a cross-sectional sample of the multilayered capacitor in Example 1. FIG. 8B illustrates an SEM image of a cross-sectional sample of the multilayered capacitor in Comparative Example 1.

Referring to FIGS. 8A and 8B, it can be seen that the pore compactness in the multilayered capacitor is significantly higher than that in Comparative Example 1.

### Evaluation Example 3: Evaluation of Dielectric Constant (ε)

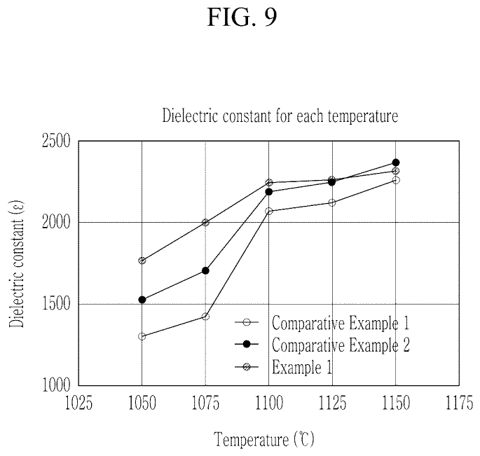

For the multilayered capacitors prepared in Example 1 and Comparative Examples 1 and 2, a dielectric constant ε was measured under a condition of 1 kHz and 1 V by using 4268A Capacitance Meter (made by Agilent) product as LCR meter equipment. By measuring the dielectric constant according to a temperature change of 1050° C. to 1150° C., a measurement result was represented in a graph illustrated in FIG. 9.

Referring to FIG. 9, it can be seen that based on the sintering temperature of 1100° C., the dielectric constant of the capacitor in Example 1 is sufficiently high, while the dielectric constants of the capacitors in Comparative Examples 1 and 2 are relatively very low.

### Evaluation Example 4: Evaluation of Moisture Resistance Reliability

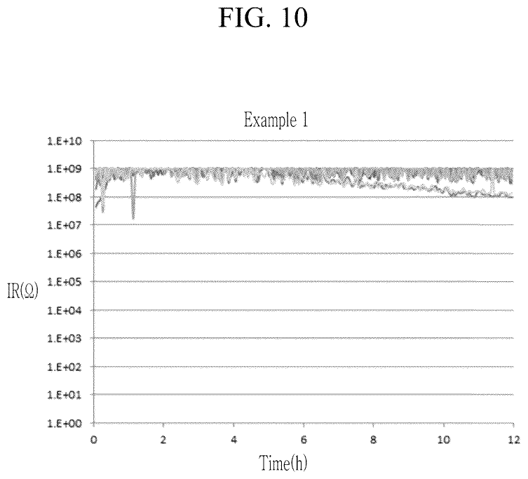

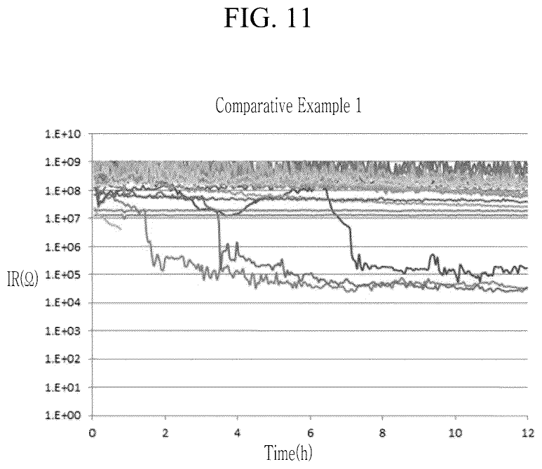

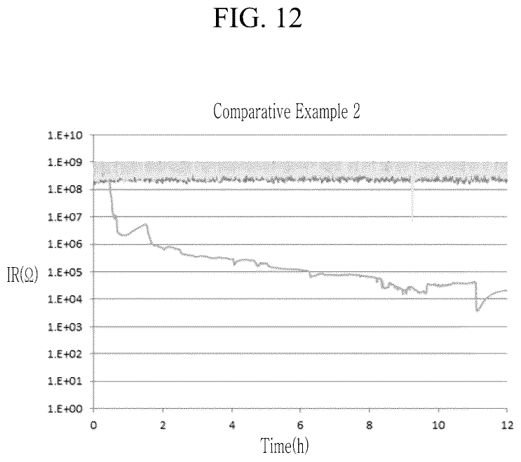

100 multilayered capacitor samples were prepared in each of Example 1 and Comparative Examples 1 and 2, and then the samples were mounted on a measurement substrate, and moisture resistance reliability for the samples was measured under of 95° C., a relative humidity (R.H.) of 85%, 13 V, and 12 hours by using ESPEC(PR-3J, 8585) equipment, and a measurement result is represented in graphs illustrated in FIGS. 10 to 12.

Through FIGS. 10 to 12, it can be seen whether resistance (IR) of the multilayered capacitor is stably maintained over time.

Referring to FIGS. 10 to 12, it can be seen that in the case of Comparative Examples 1 and 2, the resistance (IR) is lowered, and the sample is thus poor, while it can be seen that in Example 1, IR is stably maintained. As a result, it can be seen that the moisture resistance reliability of the multilayered capacitor in Example 1 is significantly superior as compared with the multilayered capacitors in Comparative Examples 1 and 2.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A dielectric composition comprising:
dielectric grains including a barium titanate-based compound; and
a secondary phase located between the dielectric grains,
wherein the secondary phase includes a first secondary phase including Ga and Si.

2. The dielectric composition of claim 1, wherein:
the dielectric grains including the barium titanate-based compound are a primary phase, and
the primary phase has an average area of 85% or more of a total area of the dielectric composition, and
the secondary phase has an average area of 15% or less of the total area of the dielectric composition.

3. The dielectric composition of claim 1, wherein:
the first secondary phase further includes Al and Mg.

4. The dielectric composition of claim 3, wherein:
the first secondary phase includes, with respect to 1 part by mol of Ga:
Si in an amount of 1.0 part by mol to 3.0 parts by mol,
Al in an amount of 0.5 parts by mol to 2.5 parts by mol, and
Mg in an amount of 0.2 parts by mol to 1.2 parts by mol.

5. The dielectric composition of claim 1, wherein:
an average area (%) occupied by the first secondary phase with respect to a total area of the secondary phase is 50% to 95%.

6. The dielectric composition of claim 5, wherein:
the secondary phase further includes a second secondary phase which includes Si and is free of Ga, and
an average area (%) occupied by the second secondary phase with respect to the total area of the secondary phase is 5% to 50%.

7. The dielectric composition of claim 6, wherein:
a ratio of the average area occupied by the first secondary phase with respect to the total area of the secondary phase to the average area occupied by the second secondary phase with respect to the total area of the secondary phase is 1.5 to 2.5.

8. The dielectric composition of claim 1, comprising Ga in an amount of 0.1 wt % to 0.5 wt %.

9. A multilayered capacitor comprising:
a capacitor body including a dielectric layer and an internal electrode; and
an external electrode disposed outside the capacitor body,
wherein the dielectric layer includes dielectric grains including a barium titanate-based compound, and a secondary phase located between the dielectric grains, and
the secondary phase includes a first secondary phase including Ga and Si.

10. The multilayered capacitor of claim 9, wherein:
the dielectric grains including the barium titanate-based compound are a primary phase,
the primary phase has an average area of 85% or more of a total area of the dielectric layer, and
the secondary phase has an average area of 15% or less of the total area of the dielectric layer.

11. The multilayered capacitor of claim 9, wherein:
the first secondary phase further includes Al and Mg.

12. The multilayered capacitor of claim 11, wherein:
the first secondary phase includes, with respect to 1 part by mol of Ga:
Si in an amount of 1.0 part by mol to 3.0 parts by mol,
Al in an amount of 0.5 parts by mol to 2.5 parts by mol, and
Mg in an amount of 0.2 parts by mol to 1.2 parts by mol.

13. The multilayered capacitor of claim 9, wherein:
an average area (%) occupied by the first secondary phase with respect to a total area of the secondary phase is 50% to 95%.

14. The multilayered capacitor of claim 13, wherein:
the secondary phase further includes a second secondary phase which includes Si and is free of Ga, and
an average area (%) occupied by the second secondary phase with respect to the total area of the secondary phase is 5% to 50%.

15. The multilayered capacitor of claim 14, wherein:
a ratio of the average area occupied by the first secondary phase with respect to the total area of the secondary phase to the average area occupied by the second secondary phase with respect to the total area of the secondary phase is 1.5 to 2.5.

16. The multilayered capacitor of claim 9, wherein the dielectric layer comprises Ga in an amount of 0.1 wt % to 0.5 wt %.

17. A manufacturing method of a multilayered capacitor, comprising:
manufacturing dielectric powder including gallium (Ga), wherein the manufacturing of the dielectric powder including the gallium (Ga) includes adding gallium (Ga) having an average particle diameter of 1 nm to 15 nm to a precursor of a barium titanate-based dielectric;
manufacturing a dielectric green sheet by utilizing the dielectric powder, and forming a conductive paste layer on a surface of the dielectric green sheet;
manufacturing a dielectric green sheet laminate by laminating a plurality of the dielectric green sheets, wherein the conductive paste layer is formed on each of the plurality of the dielectric green sheets;
manufacturing a capacitor body including a dielectric layer and an internal electrode by sintering the dielectric green sheet laminate; and
forming an external electrode on one surface of the capacitor body.

18. The manufacturing method of a multilayered capacitor of claim 17, wherein:
a sintering temperature of the sintering of the dielectric green sheet laminate is 1000° C. to 1200° C.

19. A dielectric composition comprising:
dielectric grains including a barium titanate-based compound; and
a secondary phase located between the dielectric grains, the secondary phase including a first secondary phase including Ga and Si, and a second secondary phase which includes Si and is free of Ga.

20. The dielectric composition of claim 19, wherein the dielectric composition is free of rare-earth elements.

21. The dielectric composition of claim 20, wherein:
the first secondary phase further includes Al and Mg.

22. The dielectric composition of claim 21, wherein:
the first secondary phase includes, with respect to 1 part by mol of Ga:
Si in an amount of 1.0 part by mol to 3.0 parts by mol,
Al in an amount of 0.5 parts by mol to 2.5 parts by mol, and
Mg in an amount of 0.2 parts by mol to 1.2 parts by mol.

23. The dielectric composition of claim 22, comprising Ga in an amount of 0.1 wt % to 0.5 wt %.

24. A multilayered capacitor comprising:
a capacitor body including a dielectric layer and an internal electrode; and
an external electrode disposed outside the capacitor body,
wherein the dielectric layer includes dielectric grains including a barium titanate-based compound, and a secondary phase located between the dielectric grains, and
the secondary phase including a first secondary phase including Ga and Si, and a second secondary phase which includes Si and is free of Ga.

25. The multilayered capacitor of claim 24, wherein the dielectric layer is free of rare-earth elements,
the dielectric grains including the barium titanate-based compound are a primary phase,
the primary phase has an average area of 85% or more of a total area of the dielectric layer, and
the secondary phase has an average area of 15% or less of the total area of the dielectric layer.

26. The multilayered capacitor of claim 25, wherein:
the first secondary phase further includes Al and Mg.

27. The multilayered capacitor of claim 26, wherein:
the first secondary phase includes, with respect to 1 part by mol of Ga:
Si in an amount of 1.0 part by mol to 3.0 parts by mol,
Al in an amount of 0.5 parts by mol to 2.5 parts by mol, and
Mg in an amount of 0.2 parts by mol to 1.2 parts by mol.

28. The multilayered capacitor of claim 27, wherein the dielectric layer comprises Ga in an amount of 0.1 wt % to 0.5 wt %,
an average area (%) occupied by the first secondary phase with respect to a total area of the secondary phase is 50% to 95%, and
an average area (%) occupied by the second secondary phase with respect to the total area of the secondary phase is 5% to 50%.
